(19) United States
(12) Patent Application Publication
(10) Pub. No.: US 2014/0282085 A1
(43) Pub. Date: Sep. 18, 2014

(54) METHOD FOR DISPLAYING A GRAPHIC INTERFACE WITH MESSAGE/NOTIFICATION, APPARATUS, AND NON-TRANSITORY COMPUTER-READABLE MEDIUM

(71) Applicant: National Chiao Tung University, Hsinchu City (TW)

(72) Inventors: TERNG-YIN HSU, HSINCHU CITY (TW); WEI-CHI LAI, HSINCHU CITY (TW)

(73) Assignee: NATIONAL CHIAO TUNG UNIVERSITY, Hsinchu City (TW)

(21) Appl. No.: 13/894,887

(22) Filed: May 15, 2013

(30) Foreign Application Priority Data
Mar. 18, 2013 (TW) 102109465

(51) Int. Cl. H04L 12/58

(52) U.S. Cl. CPC H04L 51/00
USPC 715/752

(57) ABSTRACT

Disclosure is related to a method for displaying a graphic interface with message/notification, an apparatus, and a computer-readable storage device. It is featured that a graphic interface is displayed on a screen of a mobile device for showing one or more messages/notifications in one limited area. This interface allows a user to preview the message before clicking the link. After that, the full content can be read while the link is opened. The method includes firstly parsing the received message/notification and retrieving the content, format, and the correlated software program. Based on numbers, formats and the correlated software programs of the messages, the content displayed onto a graphic interface is arranged. On the graphic interface, one or more preview content of the messages/notifications having profiles of specifying one or more software programs are provided for the user to click for viewing the full content.

### BACKGROUND

1. Technical Field

The present invention is related to a method for displaying a graphic interface with message/notification, an apparatus thereto, and a non-transitory computer-readable medium; in particular, a graphic interface is introduced to integrating a variety of messages/notifications, and dynamically adjusting the graphic layout thereof.

2. Description of Related Art

As the mobile devices with communication functions are now in widespread use, almost everybody holds a smart phone or tablet PC. The users usually use this kind of mobile device to exchange messages with others, or receive information. For example, the types of the messages are such as electronic mail as often seen, simple message (SMS), instant message, and the messages over a community, and the likes. The software program (e.g. APP) with associated messaging service is usually installed into the mobile device, as a daemon in the memory. This kind of program may anytime listen to any message sent from others. When the device receives one message, the processor of the mobile device may firstly initiate a process of determining the program associated to the received message. Then the use will be notified through a user interface that one message is received. It is provided that the user may tap the notification to start to read the message as launching the software program.

In the conventional technologies, it is required that user needs to tap the notification to launch the software program and to read the full message as receiving the notification. A notification center installed in the operating system of the mobile device is used to handle the messages, including receiving and displaying the messages. For example, a graphic interface may be displayed as a pull-down window or a pop-up window, and used to notify the user.

### SUMMARY

Disclosure in the application is related to a method for displaying a graphic interface with message/notification, an apparatus and a non-transitory computer-readable medium. Rather than the usual way of instantly notifying the user as any new message or notification enters, the graphic interface with message/notification in accordance with the present invention is to integrate multiple incoming messages and display the messages onto the interface with dynamic graphics using a variety of illustrations. The multiple messages may be shown at a time on the graphic interface, and in the meantime allow the user may preview all of the messages before pointing to read the full message in the later steps.

According to one of the embodiment of the present invention, the method for displaying the graphic interface with message/notification is applicable to a mobile electronic device. The mobile electronic device receives the message/notification over a mobile communication network or Internet. A data processing unit in the mobile electronic device is used to parse the received message/notification, and retrieve every message or notification's content, format and its associated software program. The method is next to arrange the content displayed on the graphic interface according to number of the messages, and format and its associated software program of the every message or notification. After that, the graphic interface with message/notification is displayed onto a screen of the mobile electronic device. The every message/notification shown on the screen allows the user to click and open the message or notification. Further, the link attached to the every message or notification is provided to associate the message/notification with a software program.

After parsing the messages/notifications, the format such as graphics, text and video or any combination thereof for the use of previewing the message or notification is obtained. The size of available area and aspect ratio of the graphic interface, and the order to receive the messages are in consideration for displaying the messages. In the method, the text amount, graphic size and order of received messages are also as the factors to consider adjusting the graphic layout. Furthermore, the number of messages shown on every page of the graphic interface may be set as an upper limit. If the number of messages exceeds the upper limit, one further new page will be rendered.

According to one of the embodiments of the present invention, the apparatus having the screen to display the graphic interface with message/notification may be a portable electronic device. In the apparatus, a communication unit is provided to receive the messages/notifications, a display unit is used to display the graphic interface with message/notification, and further a data processing unit is used to parse and receive message/notification and initiate the graphic interface. The apparatus further includes a memory unit, which is such as a computer-readable storage device, used to store instructions for displaying the graphic interface with message/notification, instructions for parsing the message/notification, instructions for retrieving content, format, and an associated software program of the every message/notification after parsing the every message or notification, instructions for initiating the graphic interface with message/notification, instructions for arranging the content displayed onto the graphic interface according to number of messages, format and associated program of the every message or notification, instructions for establishing a link between the every message or notification and its associated software program, and instructions for displaying the graphic interface with message/notification onto a screen of the apparatus.

The programs stored in the memory unit may include some other instructions for implementing the invention, for example the instructions for providing previewable graphics, text, video or any combination thereof according to an available area of the graphic interface, aspect ratio, receiving order of the messages. If the number of received messages exceeds an upper limit of the number shown in one page, instructions for adding one new page may be performed in the meantime. Instructions for dividing the page of graphic interface into multiple displayable areas according number of the received messages, or the upper limit of every page may be included. Instructions for adjusting graphic layout according the size of the area occupied by the every message or notification may be included. Instructions for adjusting the previewable text amount and graphic size according to the size of the occupied area and the aspect ratio of every area may be included. Instructions for adjusting the order for displaying the messages onto the graphic interface with message/notification may also be included.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 shows a schematic diagram of a variety of message sources over a network;

FIG. 2 shows a diagram having functional blocks for illustrating the mobile device with the graphic interface with message/notification in one embodiment of the present invention;

FIGS. 3A and 3B schematically show the diagrams describing the graphic interface with message/notification displayed on a mobile electronic device of one embodiment of the present invention;

FIG. 4 shows a flow chart illustrating the method for displaying the graphic interface with message/notification in one of the embodiments of the present invention;

FIG. 5 shows a flow chart illustrating the method for displaying the graphic interface with message/notification in one further embodiment of the present invention;

FIG. 6 shows a flow chart illustrating the method for displaying the graphic interface with message/notification according to one embodiment of the present invention;

FIG. 7 shows a flow chart illustrating the method for displaying the graphic interface with message/notification in another one embodiment of the present invention.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

Disclosure in the application is related to a method for displaying a graphic interface with message/notification, an apparatus for implementing the method, and a non-transitory computer-readable medium. One of the objectives of the invention is to provide a previewable graphic interface to integrate a variety of the incoming messages. Through this graphic interface, the content of a variety of messages to be previewed is simultaneously displayed. Therefore, a user may firstly preview the messages and then read the message or notification to be clicked.

The mentioned graphic interface may be displayed on a main page when the user turns on a mobile electronic device. The content in the graphic interface may be adjusted due to the changeable number of received messages within a period of time and the content. For example, on a page of the graphic interface, the thumbnails for showing the messages may be adjusted, the text to be previewed may be adjusted, and the area, position and order to show the every message or notification may also be adjusted. The messages may be received as a notification sent from a specific server. The messages may also be received as a software program installed in an operating system periodically sends a request of polling. Further, the messages may be the messages generated by an internal program inside the mobile electronic apparatus, for example the reminder initiated by a calendar program, todo list, hardware status such as low-voltage reminder, network throughput, or any abnormal notice.

According to one embodiment of the present invention, it is featured that a graphic interface dynamically adjusts its layout provided for the user to directly view multiple messages and their associated software programs. The size of every icon representing the associated software program may be dynamically adjusted according to the instant content. The full message or notification can be viewed when the program is launched with the user's activation.

Reference is firstly made to FIG. 1 showing a schematic diagram of the variety of message sources located over a network.

A mobile electronic device 101 is shown to acquire the variety of types of messages over a network 10. One of the types of messages is such as the electronic mail received from an electronic mail server 103. An operating system of the mobile electronic device 101 will launch an associated email program and establish a link to the message or notification when a message or notification is instantly received. One further type of message or notification is such as the message or notification delivered over a community server 104. A community program as a daemon in the operating system may periodically send polling request to the server 104 to check if any new message or notification enters. Similarly, a link between the entered community message and the associated program is established when new message or notification enters.

The operating system of the mobile electronic device 101 may able to process the notification sent from a game server 105 or any specific server when there are many game programs or the other software programs installed in the system. When the device 101 receives messages related to a specific game or program, the operating system will parse the message or notification and determine its associated program. A link between the message or notification and its associated program is then established. The messages disclosed above may be about the information of program update, new product, advertisement or the like.

There is a message server 106 may be used to process the simple message service (SMS) which is commonly used in the field of mobile communication. The message server 106 may also handle the instant messages delivered between the mobile electronic devices. When these messages enter the device 101 over the mobile communication network, the operating system is able to parse the every message or notification and determine its associated program, and therefore establish the link there-between.

Further, an information server 107 for rendering the messages such as weather, news, and advertisement to the mobile electronic device 101 is included. These messages may be periodically received by the device 101 by a process of subscription or a software program installed in the device 101.

The foregoing examples are merely some types of the messages which can be recognized by the process made by the claimed method but not used to limit the practical operation of the present invention. Most of the messages are received from outside or inside the mobile electronic device 101. The messages are the information rendered by the programs, for example the calendar, todo list, and operating status of device, and they are reachable by the graphic interface with message/notification.

Reference is made to FIG. 2 showing functional blocks illustrating the internal functional modules of the mobile electronic device 20 with the graphic interface with message/notification. The mobile electronic device 20 is such as a smart phone, tablet PC or the similar device with communication capability. The essential elements of the device 20 include a data processing unit 201, a communication unit 202, a memory unit 203, an input unit 204, and a display unit 205 which are electrically interconnected.

In an exemplary example, the device 20 is the claimed apparatus having a graphic interface with message/notification of the present invention. The communication unit 202 is used to process the packets formatted as the format available to a mobile communication network, and to receive the message/notification (22). That means the message/notification entering the device 20 is the signals delivered over the mobile communication network. The signals are from the various message sources as shown in FIG. 1. Such as electronic mail service, the mobile electronic device 20 should actively send a request to ask receiving the messages. Further, the server may also actively send the notifications, for example the message regarding program updating, news, community message, and instant message. The notifications may include the usual mobile messages such as simple message. The notifications may also be the reminders generated by the calendar program installed in the mobile device 20.

The various messages/notifications are under a parsing process executable by a data processing unit 201 and performed by a program. After parsing the messages/notifications, the content and format such as image, text, video or any combination thereof of the every message or notification may be obtained. In particular, the program also acknowledges a correlation between each message/notification and its associated software program. The data processing unit 201 then initiates a graphic interface with message/notification for displaying one or more messages/notifications. This graphic interface is used to show the messages/notifications received within a period of time. In which, a graphic layout displayed and arranged on this graphic interface may be dynamically adjusted according to the every notification's format or its attribute. For example, the program for parsing the every message/notification determines if the received message or notification attaches image(s), text(s), video(s) or any combination thereof. Therefore, a previewable picture can be defined as the graphic interface with message/notification. After that, the plurality of content-to-be-previewed messages/notifications are arranged onto the graphic interface, and then the display unit 205 is used to display the graphic layout.

To the mobile electronic device 20, the input unit 204 is as an interface provided for the user to input data and to click in reading the very message/notification. The input unit 204 may be a keypad or a touch-sensitive display. Further, the memory unit 203 or storage device in the mobile electronic device 20 is used to install the operating system 231 for operating the mobile electronic device 20. The memory unit 203 is also used to implement a notification center 232 for managing the messages/notifications. The memory unit 203 is further used to store the programs of various applications 233 installed in the mobile electronic device 20. The applications 233 are such as the APPs installed in the smart phone or tablet PC, for example the calendar program 234, todo list program, and the program notifying the hardware status.

Furthermore, the memory unit 203 stores the instructions for performing the method for displaying the graphic interface with message/notification in accordance with the present invention. The process may be referred to the flow chart shown in FIG. 4 to FIG. 7.

The programs include instructions for paring the one or more message/notification. By means the software, the claimed invention is to parse the received messages and their attachments. The programs include instructions for acquiring content, format, its associated software program and the further information thereto after parsing the every message/notification. The programs include instructions for initiating the graphic interface with message/notification, in which a window may be initiated to be a graphic interface with message/notification. Further, the instructions for adjusting a priority to display the graphic interface with message/notification are included; the instructions are used to prioritize display order of the graphic interface with message/notification.

The programs may include instructions for arranging the content displayed onto the graphic interface according to number of messages/notifications, and format and associated software program of every message or notification. The instructions are performed to dynamically arrange the layout of the graphic interface based on the every message/notification's attribute. Since the every notification occupies a specific area, the size of every area and aspect ratio thereof may be adjusted based on the attributes of the received messages. Therefore, the graphic interface may render the every message/notification to have its individual appearance shown on the graphic interface with message/notification.

The programs also include instructions for establishing a link between every message/notification and its associated software program. Since the message/notification is parsed, the associated software program for every message or notification can be acquired. The link is used to associate the every message or notification with a software program. The further instructions included are used for showing the graphic interface with message/notification on a display with the graphic layout. Therefore, the display of mobile electronic device then shows the interface after suitable arrangement.

Regarding to some specific functions, in the instructions for arranging the content displayed onto the graphic interface with message/notification, further included are the instructions for displaying to-be-previewed graphics, texts and video or any combination thereof according to size of the available area, aspect ratio, and an order to receive the messages. That means the messages/notifications shown on the graphic interface may be dynamically modified. Based on the state of the graphic interface with message/notification, the graphic layout can be dynamically modified. For example, the program may provide different modes to display the graphic interface which is dynamically modified when the device stays in a horizontal or in a vertical state.

Next, the one or more pages on the graphic interface with message/notification may be initiated. One page of the graphic interface is configured to have an upper limit of the number of messages. This upper limit allows the content shown on the every page can be clearly previewed. While the number of messages exceeds this upper limit, one new page will be added. The instructions for arranging the content shown on the graphic interface may therefore provide further instructions for adding new page when the number of total messages exceeds the upper limit.

The every message/notification shown on the graphic interface occupies one specific area. In the mentioned instructions for arranging the content displayed onto the graphic interface, further include the instructions for dividing the page of graphic interface into multiple areas according to the number of received messages, or the upper limit of the every page.

The areas of the graphic interface with message/notification are changeable due to the attribute of the various messages. In the instructions for arranging the content of the graphic interface, further instructions are included for adjusting the graphic layout such as the sizes of the areas based on the every message or notification's format. The adjustment of the graphic layout includes configuring the text-to-be-previewed and zoomable graphics. The arrangement of size of area and aspect ratio of the graphic interface are used to configure the text amount and graphic size to be previewed.

FIG. 3A and FIG. 3B schematically show the graphic interface displayed on the screen of the mobile electronic device.

A mobile electronic device 3 shown in FIG. 3A includes a display used to display the graphic interface with message/notification 30 with a highest priority. Some messages/notifications are received, and displayed on the interface according to every message or notification's attribute. For example, a first message 301, represented as APP1, and a second message, represented as APP2, are the two messages occupying two individual areas.

Further, in FIG. 3B, the graphic interface 30′ is shown on the display of the mobile electronic device 3. It appears that the number of messages/notifications increases, and simultaneously the layout of the graphic interface shows some changes. Based on the attributes of the received messages, this limited range of graphic interface is divided into multiple different sizes of areas. The messages shown in the areas are such as a third message (APP3) 303, a fourth message (APP4) 304, a fifth message (APP5) 305 and a sixth message (APP6) 306.

The aforementioned examples shown in FIGS. 3A and 3B schematically describe the content displayed onto the graphic interface with message/notification 30, 30′, and the every message/notification individually links to its associated software program. For example the link is established between the message or notification and the address the program locates in the memory, and allows the user to click to launch the corresponding software program. The link may be represented as a previewable image, for example an icon indicative of the software program may be shown on the graphic interface. Further, the previewable content may also be a portion of the texts within a limited area. The any thumbnail retrieved from the message or notification may be zoomed to fit in the area, for example the thumbnail may be created from one of the pictures attached with the message or notification, or the icon. The order of the messages shown on the interface may be modified as needs.

In an exemplary embodiment, in addition to the graphic layout of the interface is adjusted based on the messages' attributes or the various formats, the way to shown the graphic interface may also be modified according to the user's preference. The user may create a configuration file, and the layout will follow the configuration. The configuration may include the timing to show the graphic interface, for example the graphic interface may be shown on a main page as booting the device, shown instantly when any new message or notification enters, or shown regularly at intervals. Furthermore, the configuration may include the types of the messages, selection of the messages specified to some software programs, and message or notification illustrated by image-only, text-only, or in combination with a variety of illustrations. Further, the preferences of icon, order, size of area-to-be-previewed, and periodic updating may also be configured. When a user or a default user logs on the device, the configuration will be activated to dominate the scheme to show the graphic interface with message/notification.

Reference is made to FIG. 4 describing the essential steps of displaying the graphic interface with message/notification according to the present invention. A program provided for implementing method for displaying the graphic interface in the mobile device firstly receives any message/notification sent from one of the variety of sources, and reads the message or notification (step S401). The program will parse the message or notification (step S403), and the retrieve display information from the message or notification, such as the message or notification's format (step S405). After that, a link between the message or notification and its associated software program is established. For example, the format is such as an image, text, video or any combination thereof. The display information is as the previewable content for each message/notification.

Next, in step S407, the operating system may create a message/notification graphic interface within a certain display range. The messages/notifications received within a period of time and the icons of their associated programs are then dynamically arranged onto the page(s) of the graphic interface. The graphic layout may be configured based on number and format(s) of the messages. The content of texts and the size of image shown in every area may also be adjusted as requires. Further, the content shown onto the graphic interface with message/notification may be automatically arranged or zoomed based on the number of messages, format(s) of message or notification, and the user's configuration.

As the step S409, the content to be displayed on the graphic interface is determined according to attribute(s) of messages such as the mentioned number of messages, the size of every area to show the message or notification, the aspect ratio of the interface. The every previewable message or notification may be image-only, text-only, video-only, the any combination thereof. In particular, the ever message/notification is configured to indicate a link to its associated software program.

FIG. 5 describes a flow of the method according to one further embodiment. In the beginning, such as step S501, the device receives one or more messages by a specific program (APP) installed in the mobile electronic device. In step S503, the received messages are temporarily buffered in a notification center of the device. Next, an event can be triggered to initiate a message display procedure (step S505). For example, the event is such as the user logs on this mobile electronic device, taps a related program, or the timing such as launching to program periodically or hourly according to the user's configuration.

The program then reads the received message or notification (step S507), and buffered in the notification center. The program parses the messages (step S509) and retrieves the messages' formats and associated programs. The display information will be determined based on those retrieval data (step S511).

Next, in step S513, a graphic interface is created. The operating system of the device may generate the graphic interface with highest display priority. This graphic interface may also be an individual interface rather than the other windows shown on the screen. The mentioned number of messages, formats of messages, and the icon of the associated programs may form the content to be displayed on the display. In step S515, the content of graphic interface is arranged according to the number, format, and icon related to the program associated with the message or notification(s). The links between the messages and their associated programs are established (step S517). That is, the content-to-be-previewed of every displayed message or notification has a link to its associated software program. After that, the program allows the arranged content to be displayed onto the graphic interface (step S519).

In particular, the every page of the graphic interface shows the integrated messages/notifications, and simultaneously configures to have an upper limit. If the number of messages/notifications exceeds the upper limit of every page, one new page will be added. The page may be divided into multiple areas to be previewed based on the number of messages in view of the upper limit. Every message/notification occupies one area, and the size and layout of each area may be adjusted according to the message's format. The adjustment may be based on the size of occupied area, aspect ratio, text amount, and size of image.

The flow chart shown in FIG. 6 describes one further embodiment of the present invention. Step S601 shows parsing the received messages in the beginning. Step S603 shows dividing the displayable area into multiple areas based on the number of messages, and property of the graphic interface with message/notification. The content to be displayed will be determined according to the messages' formats (step S605). For example, the format is such as image, text, video or any combination thereof. After that, a link between every message or notification and its associated is established according to the result from the parsing procedure (step S607).

Next, the step S609 in the method is to determine area and position for displaying every message or notification, especially by means of software. Format of every message/notification, size and aspect ratio of the graphic interface determines the content to be previewed. The graphic layout of the interface may also be dynamically adjusted, for example the image to be previewed can be dynamically zoomed, and the text amount can be modified (step S611). In Step S613, the content with the configuration of every message or notification's content, area-to-be-previewed, and position is displayed onto the graphic interface.

The flow shown in FIG. 7 describes the process of dynamically displaying the message/notification graphic interface when any new message or notification is received. The graphic interface renders the function of dynamically adjusting the graphic layout. In one embodiment of the method, the beginning step S701 shows the program installed in the mobile device reading the message or notification(s) received within a period of time. Next, the new message or notification(s) is parsed by the program (step S703). Meanwhile, the graphic interface with message/notification is initiated (step S705), and activated to arrange the display content (step S707) and in the meantime to display the content onto the graphic interface (step S709). It is noted that the steps described in FIG. 7 may be referred to the embodiments depicted in FIGS. 4-6.

Next, the current embodiment shows, such as step S711, the method further including step of determining if any new message or notification enters when the graphic interface is displayed. If it is not found any instant message or notification entered (no). That means there is no new message or notification entered within a certain period of time, the process goes to step S709 for processing the foregoing steps.

On the contrary, such as step S713, at least one message or notification is received (yes) while the graphic interface with message/notification is displayed. According to the process described above, the newly-received message or notification(s) is firstly buffered. For example, the notification center installed in the mobile device is activated to receive and buffer the message or notification(s). As back to step S701, the program goes on parsing the message or notification(s), and further, such as steps S703 through S709, arranging the content displayed onto the graphic interface with message/notification. It is noted that the content-to-be-displayed is arranged according to format of the message or notification(s) and its associated software program, and further in view of the displayable area and aspect ratio of the graphic interface with message/notification, and also the order to receive the message or notification(s).

The present invention is also related to the non-transitory computer-readable medium which is used to store one or more programs executed by a processor for instructing the afore-described method, such as the descriptions in FIGS. 4 to 7.

To sum up, rather than the way to display the incoming messages according to the conventional art, the method for displaying the graphic interface with message/notification in accordance with the present invention renders a scheme to display the integrated messages/notifications which can be dynamically adjusted, convenient and concise to preview. Especially the user is allowed to preview the incoming messages of notifications easily through a single graphic interface; it is clearly previewing the various messages/notifications from the various types of sources.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A method for displaying a graphic interface with message/notification, adapted to a mobile electronic device, comprising:
a data processing unit of the mobile electronic device analyzing one or more messages/notifications, and retrieving each message/notification's content, format, and an associated software program;
the data processing unit initiating a graphic interface with message/notification, and arranging the content displayed in the graphic interface according to number, formats and the associated software programs of the messages/notifications; and
displaying the graphic interface with message/notification onto a display of the mobile electronic device, wherein the every displayed message/notification is configured to set a link between the message/notification and its associated software program.

2. The method of claim 1, wherein the format of the every message/notification is retrieved after analyzing the one or more messages/notifications, and the format is graphics, text or video, or any combination thereof.

3. The method of claim 2, wherein the step of arranging the content displayed in the graphic interface is arranged further includes displaying to-be-previewed graphics, text, video or any combination thereof according to size of area-to-be-displayed, aspect ratio of the graphic interface and receiving order of messages or notifications.

4. The method of claim 3, wherein the graphics-to-be-previewed is generated from an image attached with the message/notification, or an icon of the software program associated to the message/notification.

5. The method of claim 3, wherein the number of messages/notifications shown on one page of the graphic interface has an upper limit; one further page is added if the number on the page exceeds the upper limit.

6. The method of claim 5, wherein the page of the graphic interface with message/notification is divided into multiple areas according to the number of messages/notifications or the upper limit of each page.

7. The method of claim 6, wherein the every message/notification occupies one area on the page of the graphic interface, and size of the every area is adjusted according to the associated message/notification's format.

8. The method of claim 7, wherein the text amount and graphic size of the content-to-be-previewed of the every message/notification are adjusted according to the area size and the aspect ratio thereof.

9. The method of claim 1, wherein the one or more messages/notifications are firstly buffered in a notification center when the mobile electronic device receives the one or more messages/notifications.

10. The method of claim 9, wherein the content is dynamically arranged onto the graphic interface based on an instant analysis of the message/notification, including the size of area-to-be-displayed, aspect ratio of the graphic interface and receiving order of the messages or notifications when the notification center receives one new message/notification; wherein the analysis of the newly received message/notification is provided to retrieve format and the associated software program.

11. The method of claim 1, wherein the graphic interface with message/notification has the highest priority to be displayed.

12. An apparatus, which is capable of displaying a graphic interface with message/notification, comprising:
a communication unit used to receive one or more messages/notifications;
a display unit used to display the graphic interface with message/notification;
a data processing unit, electrically connected to the communication unit and the display unit, used to analyze the one or more messages/notifications and initiate the graphic interface for displaying the one or more messages/notifications;
a memory unit, electrically connected to the data processing unit, in the memory unit one or more programs to be executed by the data processing unit for displaying the graphic interface with message/notification are stored, the one or more programs includes:
instructions for analyzing the one or more messages/notifications;
instructions for retrieving content, formation and an associated software program of the every message/notification after analyzing the message/notification;
instructions for initiating the graphic interface with message/notification;
instructions for arranging the content displayed on the graphic interface in accordance with number, formats and the associated software programs of the received messages/notifications;
instructions for establishing a link between the every message/notification and the associated software program; and
instructions for displaying the graphic interface with message/notification onto a display of the apparatus.

13. The apparatus of claim 12, wherein the communication unit is used to process packets in compliance with the format over a mobile communication network.

14. The apparatus of claim 12, wherein the instructions for arranging the content displayed on the graphic interface further comprise instructions for displaying to-be-previewed graphics, text, video or any combination thereof according to size of area-to-be-displayed, aspect ratio of the graphic interface and receiving order of messages or notifications.

15. The apparatus of claim 14, wherein the instructions for arranging the content displayed onto the graphic interface further comprise instructions for adding one new page if number of the messages/notifications exceeds an upper limit.

16. The apparatus of claim 15, wherein the instructions for arranging the content displayed onto the graphic interface further comprise instructions for dividing one page of the graphic interface into multiple areas-to-be-displayed according to number of messages or notifications or the upper limit of each page.

17. The apparatus of claim 16, wherein the instructions for arranging the content displayed onto the graphic interface further comprise instructions for adjusting size of the area to be occupied by the every message/notification according to the format of the message/notification.

18. The apparatus of claim 16, wherein the instructions for arranging the content displayed onto the graphic interface further comprise instructions for adjusting the to-be-previewed text amount and graphic size for the each message/notification according to size of area-to-be-displayed and an aspect ratio of the graphic interface.

19. The apparatus of claim 12, wherein the instructions for displaying the graphic interface with message/notification further comprise instructions for adjusting an order to display the received messages on the graphic interface with message/notification.

20. A non-transitory computer-readable medium used to store one or more programs executed by a processor for instructing the method according to claim 1.
